(19) United States
(12) Patent Application Publication
(10) Pub. No.: US 2026/0028551 A1
(43) Pub. Date: Jan. 29, 2026

(54) GRANULAR LAUNDRY DETERGENT COMPOSITION

(71) Applicant: THE PROCTER & GAMBLE COMPANY, Cincinnati, OH (US)

(72) Inventor: Andres Arturo MARTINEZ GUZMAN, Newcastle upon Tyne (GB)

(21) Appl. No.: 19/254,846

(22) Filed: Jun. 30, 2025

(30) Foreign Application Priority Data
Jul. 29, 2024 (EP) 24191418.3

(51) Int. Cl. C11D 1/37; C11D 1/14; C11D 1/22; C11D 1/29; C11D 3/10; C11D 3/12; C11D 11/00; C11D 17/06

(52) U.S. Cl. CPC C11D 1/37; C11D 3/10; C11D 3/122; C11D 3/1246; C11D 11/0082; C11D 17/06; C11D 1/146; C11D 1/22; C11D 1/29

(57) ABSTRACT

A granular laundry detergent composition containing a first granule, a method making the granular laundry detergent composition and a method of using the granular laundry detergent composition.

### FIELD OF THE INVENTION

The present invention relates to a granular laundry detergent composition, method of making and method of use.

### BACKGROUND OF THE INVENTION

Granular laundry detergent compositions are well known. They can be used in both automatic, semi-automatic or handwash operations. During a hand wash or a semi-automatic operation, consumers associate the presence of wash suds with effectiveness of the laundry detergent. Therefore, there is a need to create suds quickly upon formation of the wash liquor and also to maintain the suds throughout the wash operation.

Whilst previous efforts have achieved longevity of suds in the wash liquor, there is an unmet need to improve the speed of suds generation at the start of the wash operation. Ideally, there is a need to improve the speed of suds generation at the start of the wash operation followed by improved reduction of the suds at the end of wash operation.

It was surprisingly found that the present invention achieved provided for such a benefit.

### SUMMARY OF THE INVENTION

A first aspect of the present invention is a laundry detergent composition, wherein said composition comprises at least a first granule, wherein said first granule comprises an anionic surfactant and optionally an inorganic salt; wherein said first granule comprises between 2% and 40%, or between 5% and 25%, or even between 8% and 22% by weight of the first granule of the anionic surfactant and optionally between 1% and 70%, or between 2% and 40% by weight of the first granule of the inorganic salt, and wherein the anionic surfactant comprises linear alkylbenzene sulphonate and linear alkyl sulphate, and wherein the weight ratio of linear alkylbenzene sulphonate to alkyl sulphate is between 0.5:1 to 2:1.

A second aspect of the present invention is a process for making a granular laundry detergent composition according to the first aspect of the invention comprising the steps of;
a. creating a slurry comprising the anionic surfactants and optionally the inorganic salt;
b. converting said slurry in a plurality of the first granule;
c. optionally mixing the first granule with the second granule.

A third aspect of the present invention is a process of washing a fabric comprising the steps of;
a. mixing water and a granular laundry detergent composition according to the present invention to create a wash liquor;
b. Adding a fabric to be cleaned to said wash liquor;
c. Agitating the wash liquor by hand.
preferably, wherein the water has a hardness of from 1 to 25 grains per gallon.

### DETAILED DESCRIPTION OF THE INVENTION

### Laundry Detergent Composition

The present invention is to a laundry detergent composition. A laundry detergent composition should be understood as a composition used in the treatment of fabrics during a fabric treatment operation. Such treatment can include cleaning, softening, refreshing or a mixture thereof. Preferably the fabric treatment results in fabric cleaning.

Those skilled in the art will be aware of suitable fabric treatment processes. Such processes can be manual, semi-automatic or automatic. Automatic processes typically are conducted in automatic washing machines. Those skilled in the art will be aware of suitable temperature, time and water volumes necessary for the cleaning operation. Those skilled in the art will be aware of suitable quantities of the laundry detergent composition for the cleaning process.

Any suitable fabric may be used. Suitable fabrics include synthetic materials, natural materials or a mixture thereof. Preferably between 1 kg and 10 kg, or even between 1 kg and 8 kg of fabrics are used in the process. The fabrics can be the same or similar colours, or can be a range of different colours.

The fabrics may be washed at a temperature of between 15° C. and 50° C., preferably between 15° C. and 30° C.

Other laundry additives, such as fabric softeners or freshness additives may also be added to the fabrics. Such additives may be added at the same time or a different time to the granular laundry detergent composition.

The process may take between 15 mins and 4.5 hours, or even between 15 mins and 2.5 hours, or even between 15 mins and 1.5 hours to complete.

Typically, the granular laundry detergent composition is a fully formulated laundry detergent composition, not a portion thereof such as a spray-dried, extruded or agglomerate particle that only forms part of the laundry detergent composition. Typically, the granular laundry detergent composition comprises a plurality of chemically different particles, such as spray-dried base detergent particles and/or agglomerated base detergent particles and/or extruded base detergent particles, in combination with one or more, typically two or more, or five or more, or even ten or more particles selected from: surfactant particles, including surfactant agglomerates, surfactant extrudates, surfactant needles, surfactant noodles, surfactant flakes; phosphate particles; zeolite particles; silicate salt particles, especially sodium silicate particles; carbonate salt particles, especially sodium carbonate particles; polymer particles such as carboxylate polymer particles, cellulosic polymer particles, starch particles, polyester particles, polyamine particles, terephthalate polymer particles, polyethylene glycol particles; aesthetic particles such as coloured noodles, needles, lamellae particles and ring particles; enzyme particles such as protease granulates, amylase granulates, lipase granulates, cellulase granulates, mannanase granulates, pectate lyase granulates, xyloglucanase granulates, bleaching enzyme granulates and co-granulates of any of these enzymes, preferably these enzyme granulates comprise sodium sulphate; bleach particles, such as percarbonate particles, especially coated percarbonate particles, such as percarbonate coated with carbonate salt, sulphate salt, silicate salt, borosilicate salt, or any combination thereof, perborate particles, bleach activator particles such as tetra acetyl ethylene diamine particles and/or alkyl oxybenzene sulphonate particles, bleach catalyst particles such as transition metal catalyst particles, and/or isoquinolinium bleach catalyst particles, pre-formed peracid particles, especially coated pre-formed peracid particles; filler particles such as sulphate salt particles and chloride particles; clay particles such as montmorillonite particles and particles of clay and silicone; flocculant particles such as polyethylene oxide particles; wax particles such as wax agglomerates; silicone particles, brightener particles; dye transfer inhibition particles; dye fixative particles; perfume particles such as perfume microcapsules and starch encapsulated perfume accord particles, or pro-perfume particles such as Schiff base reaction product particles; hueing dye particles; chelant particles such as chelant agglomerates; and any combination thereof.

Suitable laundry detergent compositions can comprise a detergent ingredient selected from: detersive surfactant, such as anionic detersive surfactants, non-ionic detersive surfactants, cationic detersive surfactants, zwitterionic detersive surfactants and amphoteric detersive surfactants; polymers, such as carboxylate polymers, soil release polymer, anti-redeposition polymers, cellulosic polymers and care polymers; bleach, such as sources of hydrogen peroxide, bleach activators, bleach catalysts and pre-formed peracids; photobleach, such as such as zinc and/or aluminium sulphonated phthalocyanine; enzymes, such as proteases, amylases, cellulases, lipases; zeolite builder; phosphate builder; co-builders, such as citric acid and citrate; carbonate, such as sodium carbonate and sodium bicarbonate; sulphate salt, such as sodium sulphate; silicate salt such as sodium silicate; chloride salt, such as sodium chloride; chelants; hueing agents; dye transfer inhibitors; dye fixative agents; perfume; silicone; fabric softening agents, such as clay; flocculants, such as polyethyleneoxide; suds suppressors; and any combination thereof.

The laundry detergent composition comprises at least a first granule, wherein said first granule comprises an anionic surfactant and optionally an inorganic salt. The first granule is described in more detail below.

The laundry detergent composition may comprise a second granule. The second granule is described in more detail below.

The detergent composition may comprise between 0.1 and 99%, or between 20% and 80%, or between 30% and 70%, or between 40% and 60% by weight of the composition of the first granule.

The detergent composition may be in the form of a free flowing granular detergent, a compressed tablet, a unit dose article wherein the detergent composition is contained within and/or on the unit dose article, or a mixture thereof.

Without wishing to be bound by theory, the water-soluble unit dose article comprises a water-soluble non-woven sheet, wherein;
a. The non-woven sheet is shaped to create an internal compartment and the granular laundry detergent composition is housed within said compartment;
   or
b. The non-woven sheet is orientated into layers, the layers stacked on top of one another, and the granular laundry detergent composition is positioned between said layers.

The water-soluble fibrous non-woven sheet comprises a plurality of fibers. Preferably, the fibers are inter-entangled fibers in the form of a fibrous structure.

The water-soluble fibrous non-woven sheet may be homogeneous or may be layered. If layered, the water-soluble fibrous non-woven sheet may comprise at least two and/or at least three and/or at least four and/or at least five layers.

Preferably, the water-soluble fibrous non-woven sheet has a basis weight of between 20 gsm and 60 gsm, preferably between 20 gsm and 55 gsm, more preferably between 25 gsm and 50 gsm, most preferably between 25 gsm and 45 gsm. Those skilled in the art will be aware of methods to measure the basis weight.

By ‘fiber’ we herein mean an elongated element having a length exceeding its average diameter, preferably, a length to average diameter ratio of at least about 10.

Preferably, each fiber may have a length of greater than or equal to 5.08 cm, greater than or equal to 7.62 cm, greater than or equal to 10.16, greater than or equal to 15.24 cm or a mixture thereof.

Alternatively, each fiber may have length of less than 5.08 cm, less than 3.81 cm, less than 2.54 cm, or a mixture thereof.

Each fiber may have a width of less than 100 μm, less than 75 μm, less than 50 μm, less than 25 μm, less than 10 μm, less than 5 μm, less than 1 μm or a mixture thereof. Those skilled in the art will be aware of standard methods and techniques to measure the width. Preferred methods include Scanning Electron Microscope (SEM) or an Optical Microscope together with image analysis software.

The water-soluble fibrous non-woven sheet may comprise a plurality of identical or substantially identical, from a compositional perspective, fibers. Alternatively, the water-soluble fibrous non-woven sheet may comprise two or more different fibers according to the present invention. Non-limiting examples of differences in the fibers may be physical differences such as differences in diameter, length, texture, shape, rigidness, elasticity, and the like; chemical differences such as crosslinking level, solubility, melting point, Tg, active agent.

Preferably, the fibers are present between 80% and 95%, preferably between 85% and 93%, more preferably between 87% and 90% by weight of the water-soluble fibrous non-woven sheet.

The water-soluble fibrous non-woven sheet may exhibit different regions, such as different regions of basis weight, density, and/or caliper. The water-soluble fibrous non-woven sheet may comprise texture on one or more of its surfaces. A surface of the water-soluble fibrous non-woven sheet may comprise a pattern, such as a non-random, repeating pattern.

The water-soluble fibrous non-woven sheet may have a thickness between 0.01 mm and 100 mm, preferably between 0.05 mm and 50 mm, more preferably between 0.1 mm and 20 mm, even more preferably between 0.1 mm and 10 mm, even more preferably between 0.1 mm and 5 mm, even more preferably between 0.1 mm and 2 mm, even more preferably between 0.1 mm and 0.5 mm, most preferably between 0.1 mm and 0.3 mm. Those skilled in the art will be aware of standard methods to measure the thickness.

The fibers may comprise a polyvinyl alcohol polymer. Preferably, the fibers comprise between 50% and 98%, preferably between 65% and 97%, more preferably between 80% and 96%, even more preferably between 88% and 96% by weight of the fiber of polyvinyl alcohol.

The polyvinyl alcohol polymer may have a weight average molecular weight of between 50 kDa and 150 kDa, preferably between 75 kDa and 140 kDa, more preferably between 100 kDa and 130 kDa. “Weight average molecular weight” as used herein means the weight average molecular weight as determined using gel permeation chromatography according to the protocol found in Colloids and Surfaces A. Physico Chemical & Engineering Aspects, Vol. 162, 2000, pg. 107-121. Those skilled in the art will be aware of other known techniques to determine the weight average molecular weight (MW).

Preferably, the polyvinyl alcohol polymer is a polyvinyl alcohol homopolymer. Preferably, the polyvinyl alcohol homopolymer has an average percentage degree of hydrolysis of from 75% to 100%, preferably of from 80% to 95%, most preferably of from 85% to 90%. Preferably, the polyvinyl alcohol homopolymer has an average viscosity of from 1 to 30 mPas, preferably from 5 to 25 mPas, most preferably from 10 to 20 mPas, wherein the viscosity is measured as a 4% aqueous solution in demineralized water at 20° C.

The fibers preferably comprise between 0.1% and 15% by weight of the fibers of a gel-breaker, wherein the gel-breaker is selected from polyols, sugar alcohols, amines, amides, carbohydrates, multivalent cations, or a mixture thereof, preferably polyols, sugar alcohols or a mixture thereof. Preferably, the fibers comprise between 1% and 12%, preferably between 2% and 10% by weight of the fibers of the gel-breaker.

### First Granule

The laundry detergent composition comprises a first granule. The first granule comprises an anionic surfactant and optionally an inorganic salt.

The first granule comprises between 2% and 40%, or between 5% and 25%, or even between 8% and 22% by weight of the first granule of anionic surfactant and optionally between 1% and 70%, or between 2% and 40% by weight of the first granule of the inorganic salt.

The anionic surfactant comprises linear alkylbenzene sulphonate and linear alkyl sulphate, and the weight ratio of linear alkylbenzene sulphonate to alkyl sulphate is between 0.5:1 to 2:1.

The alkyl benzene sulphonates is preferably a C₁₀₋₁₃ alkyl benzene sulphonate. Suitable alkyl benzene sulphonate (LAS) is obtainable, preferably obtained, by sulphonating commercially available linear alkyl benzene (LAB); suitable LAB includes low 2-phenyl LAB, other suitable LAB include high 2-phenyl LAB, such as those supplied by Sasol under the tradename Hyblene®.

Suitable sulphate detersive surfactants include alkyl sulphate, preferably C₈₋₁₈ alkyl sulphate, or predominantly C₁₂ alkyl sulphate.

The alkyl sulphate may unethoxylated or ethoxylated. Preferably the alkyl sulphate unethoxylated. If the alkyl sulphate is ethoxylated, preferably it has an average degree of ethoxylation between 1 and 25, or even between 1 and 11, or even between 3 and 7.

The alkyl alkoxylated sulphate may be an a C₈₋₁₈ alkyl ethoxylated sulphate.

The linear alkyl benzene sulphonates may be substituted or un-substituted, and may be derived from petrochemical material or biomaterial.

The alkyl sulphate and alkyl alkoxylated sulphate may be linear or branched, substituted or un-substituted, and may be derived from petrochemical material or biomaterial.

Without wishing to be bound by theory, the co-formulation of the anionic surfactants into the same particle enables addition of alkyl sulphate materials without negative aesthetic qualities. Addition of higher levels of alkyl sulphate materials to a granular laundry detergent composition comprising alkyl benzene sulphonates can result in negative aesthetic qualities and a loss in drying efficiency. However, such negatives were minimized by formulating the alkyl sulphate material as according to the present invention.

Other suitable anionic detersive surfactants include alkyl ether carboxylates.

The cation from the linear alkylbenzene sulphonate may be selected from Alkali and Alkaline Earth metals. Preferably, the linear alkylbenzene sulfonate has a chain length of C8, C10, C12, C14 or C16, or mixtures thereof.

The alkyl sulphate may be selected from Alkali and Alkaline Earth metals or mixtures thereof. Preferably, the alkyl sulphate has a chain length of C8, C10, C12, C14, C16 or C18, or mixtures thereof.

The granular laundry detergent composition may comprise between 2% and 40%, 5% and 25%, or between 8% and 22% by weight of the granular detergent composition of the anionic surfactant.

The first granule may comprise dyes, ethoxylated material or a mixture thereof.

The ethoxylated material may be selected from water-soluble ethoxylated materials. The ethoxylate chain in the ethoxylated material comprises a number of repeating units of ethylene glycol and the number of repeating units of ethylene glycol may be higher than 10, preferably higher than 20. The ethoxylate in the ethoxylated material may be attached to another ethoxylate chain or to a hydrophilic group. The hydrophilic group may include —NH2, —OH, —COOH, C═O, —SO₃—, SO₄²⁻ or a mixture thereof.

Examples of ethoxylated material include water-soluble polyethylene glycol, preferably with a molecular weight<8000 Da, more preferably <5000 Da or polyethyleneimine ethoxylated.

Without wishing to be bound by theory, the addition of the ethoxylated material helps control the viscosity of the surfactant mixture when making the first granule. This aids in manufacture and processing of the first granule.

The detergent composition optionally comprises an inorganic salt. The inorganic salt may be selected from alkali metal salts, alkaline earth metal salts or a mixture thereof, preferably selected from alkali metal carbonate, alkali metal sulphate, alkali metal silicate, alkali metal chloride, or a mixture thereof. Without wishing to be bound by theory, the presence of the inorganic salt has the benefit of further enhancing the initial foam generation.

The detergent composition may optionally also comprise polymers, brighteners and dyes.

The first granule may be in the form of a spray-dried granule, an agglomerate, drum dried flake, an extrudate or a mixture thereof. Preferably, the first granule is in the form of a spray-dried granule.

Typically, a suitable spray-drying process comprises the step of forming an aqueous slurry mixture, transferring it through at least one pump, preferably two pumps, to a pressure nozzle. Atomizing the aqueous slurry mixture into a spray-drying tower and drying the aqueous slurry mixture to form spray-dried particles. Preferably, the spray-drying tower is a counter-current spray-drying tower, although a co-current spray-drying tower may also be suitable.

Typically, the spray-dried powder is subjected to cooling, for example an air lift. Typically, the spray-drying powder is subjected to particle size classification, for example a sieve, to obtain the desired particle size distribution. Preferably, the spray-dried powder has a particle size distribution such that weight average particle size is in the range of from 300 micrometers to 500 micrometers, and less than 10 wt % of the spray-dried particles have a particle size greater than 2360 micrometers.

It may be preferred to heat the aqueous slurry mixture to elevated temperatures prior to atomization into the spray-drying tower.

### Second Granule

The granular laundry detergent composition may comprise at least a second granule. The second granule may comprise a polymer, hueing dye, enzyme, optical brightener, perfume, alkali source, inorganic filler, supplementing surfactant particle, or a mixture thereof.

Suitable polymers include carboxylate polymers, soil release polymers, anti-redeposition polymers, cellulosic polymers, care polymers and any combination thereof.

The hueing dye may be selected from direct violet 9, direct violet 66, direct violet 99, acid violet 50, solvent violet 13, or a combination thereof. The granular laundry detergent composition may comprise between 0.1% and 10% by weight of the granular laundry detergent composition of the hueing dye.

The hueing dye may have the following structure;

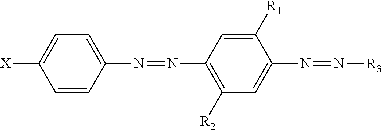

wherein: R1 and R2 are independently selected from the group consisting of: H; alkyl; alkoxy; alkyleneoxy; alkyl capped alkyleneoxy; urea; and amido; R3 is a substituted aryl group; X is a substituted group comprising sulfonamide moiety and optionally an alkyl and/or aryl moiety, and wherein the substituent group comprises at least one alkyleneoxy chain that comprises an average molar distribution of at least four alkyleneoxy moieties.

The hueing dye may have the following structure:

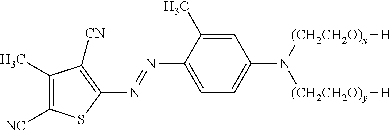

wherein the index values x and y are independently selected from 1 to 10.

Suitable enzymes include lipases, proteases, cellulases, amylases and any combination thereof.

Suitable fluorescent brighteners include: di-styryl biphenyl compounds, e.g. Tinopal® CBS-X, di-amino stilbene di-sulfonic acid compounds, e.g. Tinopal® DMS pure Xtra and Blankophor® HRH, and Pyrazoline compounds, e.g. Blankophor® SN, and coumarin compounds, e.g. Tinopal® SWN. Preferred brighteners are: sodium 2 (4-styryl-3-sulfophenyl)-2H-napthol [1,2-d]triazole, disodium 4,4′-bis{[(4-anilino-6-(N methyl-N-2 hydroxyethyl)amino 1,3,5-triazin-2-yl)]; amino}stilbene-2-2′ disulfonate, disodium 4,4′-bis{[(4-anilino-6-morpholino-1,3,5-triazin-2-yl)]amino} stilbene-2-2′ disulfonate, and disodium 4,4′-bis(2-sulfostyryl) biphenyl. A suitable fluorescent brightener is C.I. Fluorescent Brightener 260, which may be used in its beta or alpha crystalline forms, or a mixture of these forms.

Suitable perfumes comprise perfume materials selected from the group: (a) perfume materials having a C log P of less than 3.0 and a boiling point of less than 250° C. (quadrant 1 perfume materials); (b) perfume materials having a C log P of less than 3.0 and a boiling point of 250° C. or greater (quadrant 2 perfume materials); (c) perfume materials having a C log P of 3.0 or greater and a boiling point of less than 250° C. (quadrant 3 perfume materials); (d) perfume materials having a C log P of 3.0 or greater and a boiling point of 250° C. or greater (quadrant 4 perfume materials); and (c) mixtures thereof. It may be preferred for the perfume to be in the form of a perfume delivery technology. Such delivery technologies further stabilize and enhance the deposition and release of perfume materials from the laundered fabric. Such perfume delivery technologies can also be used to further increase the longevity of perfume release from the laundered fabric. Suitable perfume delivery technologies include: perfume microcapsules, pro-perfumes, polymer assisted deliveries, molecule assisted deliveries, fiber assisted deliveries, amine assisted deliveries, cyclodextrin, starch encapsulated accord, zeolite and other inorganic carriers, and any mixture thereof.

The filler material may be selected from alkali metal carbonates, alkali metal sulphonates, clays, zeolites, silicates, sodium chloride or a mixture thereof.

The granular laundry detergent composition may have a reserve alkalinity to pH 9.5 of less than 5.0 gNaOH/100 g. The laundry detergent composition may have a pH of between 8 and 11 as measured by a 10% solution at 25° C. in deionised water.

### Process of Making

A further aspect of the present invention is a process for making a granular laundry detergent composition according to the present invention comprising the steps of;
a. creating a slurry comprising the anionic surfactants and optionally the inorganic salt;
b. converting said slurry in a plurality of the first granule;
c. optionally mixing the first granule with the second granule.

Those skilled in the art will be aware of how to make an appropriate slurry. Without wishing to be bound by theory, the slurry comprises the anionic surfactant and water, or some other suitable liquid. The slurry is then added via the relevant process apparatus in order to make the dried granule. The first granule may be made by spray-drying, agglomeration, drum drying, extruding or a mixture thereof. The level of surfactant in the slurry may vary between 5% and 30% by weight of the slurry, and the level of water in the slurry may vary between 20% and 70% by weight of the slurry. Optionally, inorganic salts may be added to the slurry at a level of between 0% and 75% by weight of the slurry. The slurry may optionally also contain polymers, brighteners, and dyes.

When making the slurry, the alkyl sulphate may first be mixed with the linear alkylbenzene sulphonate to create an intermediate mixture. This intermediate mixture may then optionally be mixed with the inorganic salt. Without wishing to be bound by theory, this specific order of addition of ingredients surprisingly resulted in improved performance of the granular laundry detergent composition in high water hardness.

The alkyl sulphate material comes in the form of an aqueous paste with water content typically between 30% and 80% most commonly between 60% and 80% by weight of the aqueous paste. Those skilled in the art will be aware the use of water in the alkyl sulphate paste helps control the viscosity of such paste for efficient processing.

Optionally, the alkyl sulphate paste used in the present invention comprises the ethoxylated material as described herein. As detailed earlier, without wishing to be bound by theory, the addition of the ethoxylated material helps control the viscosity of the alkyl sulphate paste when making the first granule. This aids in manufacture and processing of the first granule.

### Process of Use

A further aspect of the present invention is a process of washing a fabric comprising the steps of;
a. mixing water and a granular laundry detergent composition according to the present invention to create a wash liquor;
b. Adding a fabric to be cleaned to said wash liquor;
c. Agitating the wash liquor by hand.
preferably, wherein the water has a hardness of from 1 to 25 grains per gallon.

Any suitable fabric may be used. Suitable fabrics include synthetic materials, natural materials or a mixture thereof. Preferably between 1 kg and 10 kg, or even between 1 kg and 8 kg of fabrics are used in the process. The fabrics can be the same or similar colours, or can be a range of different colours.

The fabrics may be washed at a temperature of between 15° C. and 50° C., preferably between 15° C. and 30° C.

Other laundry additives, such as fabric softeners or freshness additives may also be added to the fabrics. Such additives may be added at the same time or a different time to the granular laundry detergent composition.

The process may be a manual one, an automated one or a mixture thereof.

The process may take between 15 mins and 4.5 hours, or even between 15 mins and 2.5 hours, or even between 15 mins and 1.5 hours to complete.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

### EXAMPLES

### Example 1

A Laundry Powder formulation Powder A (comparative) with a LAS:AS ratio of 9:1 was prepared by Spray-Drying a blend of Linear Alkyl Benzene Sulphonate, Sodium Carbonate, Acrylic/Maleic Acid Sodium Salt, Silicic Acid Sodium Salt, Sodium Sulphate, Dyes & Water (as per Table 1) using a Pilot Plant sized Spray-Drying Unit. The spray-dried granules were dried to a moisture of ˜2.5%, then sieved to remove particles>1600 μm. The resulting sample was then admixed with a Linear Alkyl Sulphate Particle, Polymer, Enzymes, Brighteners, Inorganic Filler & Flow Aid, as shown in Table 1.

Separately, a formulation Powder B (according to the present invention) with a LAS:AS ratio of 1:1 was prepared by Spray-Drying a blend of Linear Alkyl Sulphate, Linear Alkyl Benzene Sulphonate, Sodium Carbonate, Acrylic/Maleic Acid Sodium Salt, Silicic Acid Sodium Salt, Sodium Sulphate, Dyes & Water (as per Table 1) using a Pilot Plant sized Spray-Drying Unit. The spray-dried granules were dried to a moisture of ˜2.5%, then sieved to remove particles>1600 μm. The resulting sample was then admixed with Polymer, Enzymes, Brighteners, Inorganic Filler & Flow Aid, as shown in Table 2.

Both Powder A & Powder B were dissolved in 500 ml of Water with a Hardness of 22 grains per gallon, at 25 degrees C., inside cylindrical containers to prepare wash liquors with a concentration of 378 ppm of Linear Alkyl Benzene Sulphonate & 42 ppm of Alkyl sulphate (for Powder A); and 210 ppm of Linear Alkyl Benzene Sulphonate & 210 ppm of Alkyl sulphate (for Powder B)

TABLE 1
Composition of Spray-Dried Particles
comprised in Powders A & B

| | Spray-Dried | Spray-Dried |
|---|---|---|
| | Particle in | Particle in |
| | POWDER A | POWDER B |
| Linear Alkyl Sulphate | 0.00% | 10.80% |
| Linear Alkyl Benzene Sulphonate % | 19.41% | 10.80% |
| Sodium Carbonate % | 15.02% | 15.02% |
| Acrylic/Maleic Acid Sodium Salt % | 1.06% | 1.06% |
| Silicic Acid Sodium Salt % | 8.39% | 8.39% |
| Sodium Sulphate % | 53.57% | 51.38% |
| Dyes % | 0.05% | 0.05% |
| Water % (after drying) | 2.5% | 2.5% |

TABLE 2
Composition of Powders A & B

| | POWDER A | POWDER B |
|---|---|---|
| Spray-Dried Particle % (containing | 80.67% | 80.67% |
| Linear Alkyl Benzene Sulphonate) | | |
| Linear Alkyl Sulphate Particle % | 1.86% | 0.00% |
| (Activity = 96%) | | |
| Ethoxylated Fatty Alcohol % | 0.30% | 0.30% |
| Polymer % | 0.45% | 0.45% |
| Enzymes % | 0.50% | 0.50% |
| Optical Brighteners % | 0.10% | 0.10% |
| Inorganic Filler % | 15.19% | 17.05% |
| Flow Aids % | 0.93% | 0.93% |

The wash liquors in the cylindrical containers were tumbled at a constant rotational speed of 30 revolutions per minute, during time lapses as shown in Table 3.

After 240 seconds in the Experiment, 160 microlitres of Technical Body Soil were added to each wash liquor to mimic soils being released from fabrics being washed, before tumbling resume for 4 more lapses.

As it can be observed in Table 3, the foam height reached in Powder B during the 420 seconds of Tumbling is significantly higher than that reached for Powder A demonstrating the improved initial suds generation benefit of the present invention.

TABLE 3
Foam height measured inside Tumbling Cylinder over different
time lapses, prior and after addition of Technical Body Soil

| | | | | Delta |
|---|---|---|---|---|
| | | | | [Powder B − |
| | Time lapse | Powder A | Powder B | Powder A] |
| | (seconds) | (cm) | (cm) | (cm) |
| No Technical | 0 | 0.0 | 0.0 | 0.0 |
| Body Soil | 60 | 6.9 ± 0.2 | 8.1 ± 0.2 | +1.2 |
| added | 120 | 8.4 ± 0.4 | 10.4 ± 0.2 | +1.9 |
| | 180 | 10.2 ± 0.4 | 12.7 ± 0.6 | +2.5 |
| 160 microlitres | 240 | 7.8 ± 0.6 | 9.5 ± 0.9 | +1.7 |
| of Technical | 300 | 8.2 ± 1.2 | 10.5 ± 0.8 | +2.3 |
| Body soil | 360 | 9.4 ± 1.0 | 11.0 ± 0.8 | +1.6 |
| added | 420 | 9.7 ± 1.1 | 11.4 ± 1.2 | +1.7 |

Following the improved initial suds generation, suds were seen to reduce up to 1020 seconds demonstrating the improved initial suds generation and later suds reduction.

### Example 2

Four Laundry Powder formulations, Powder C (Comparative) & Powder D (comparative), Powder E (comparative) and Powder F (comparative), all with a LAS:AS ratio of 1:1, were prepared by admixing an LAS-containing granule, with a separate alkyl sulphate-containing particle. For the sake of demonstrating various manufacturing processes and particle size ranges, the manufacturing route for the LAS-containing granule in the 4 laundry formulations included Agglomeration, Drum-Drying & Spray-Drying, as shown in Table 4. The resulting mixtures were then admixed with Silicic Acid Sodium Salt Particle & Inorganic filler, as shown in Table 5.

Separately, a Powder G (according to the present invention) was produced by spray-drying a particle comprising both Linear Alkyl Benzene Sulphonate and Alkyl sulphate, where the 2 anionic surfactants are co-located (as per present invention). Silicic Acid Sodium Salt, Acrylic/Maleic Acid Sodium Salt, sodium Carbonate & Inorganic filler were also added to deliver a final composition identical to Powder F (comparative).

TABLE 4
Composition of Particle composition
comprised in Powders C, D, E, F and G

| | LAS- | LAS- | LAS- | LAS- | Combined |
|---|---|---|---|---|---|
| | carrier | carrier | carrier | carrier | anionic |
| | Particle in | Particle in | Particle in | Particle in | particle in |
| | POWDER | POWDER | POWDER | POWDER | POWDER |
| | C | D | E | F | G |
| Manufac- | Agglom- | Agglom- | Flake | Spray- | Spray- |
| turing route | erate | erate | | Drying | Drying |
| Particle Size | 710-850 | 250-400 | 50-1600 | 50-1600 | 50-1600 |
| Range | um | um | um | um | um |
| Linear Alkyl | 0.00% | 0.00% | 0.00% | 0.00% | 10.80% |
| Sulphate % | | | | | |
| Linear Alkyl | 21.00% | 21.00% | 91.00% | 19.41% | 10.80% |
| Benzene | | | | | |
| Sulphonate | | | | | |
| % | | | | | |
| Sodium | 39.73% | 39.73% | 0.00% | 15.02% | 15.02% |
| Carbonate % | | | | | |
| Acrylic/ | 0.00% | 0.00% | 0.00% | 1.06% | 1.06% |
| Maleic Acid | | | | | |
| Sodium | | | | | |
| Salt % | | | | | |
| Silicic Acid | 0.00% | 0.00% | 0.00% | 8.39% | 8.39% |
| Sodium | | | | | |
| Salt % | | | | | |
| Sodium | 38.62% | 38.62% | 8.50% | 53.62% | 51.43% |
| Sulphate % | | | | | |
| Water % | 0.65% | 0.65% | 0.50% | 2.50% | 2.50% |

TABLE 5
Composition of Powders C, D, E, F and G

| | POWDER | POWDER | POWDER | POWDER | POWDER |
|---|---|---|---|---|---|
| | C | D | E | F | G |
| Combined | 0.00% | 0.00% | 0.00% | 0.00% | 100.00% |
| anionic | | | | | |
| surfactant | | | | | |
| particle | | | | | |
| LAS | 43.33% | 83.18% | 10.84% | 83.18% | 0.00% |
| Particle % | | | | | |
| (containing | | | | | |
| Linear Alkyl | | | | | |
| Benzene | | | | | |
| Sulphonate) | | | | | |
| Linear Alkyl | 9.48% | 16.82% | 10.28% | 16.82% | 0.00% |
| Sulphate | | | | | |
| Particle % | | | | | |
| (Activity = | | | | | |
| 96%) | | | | | |
| Sodium | 0.00% | 0.00% | 13.72% | 0.00% | 0.00% |
| Carbonate % | | | | | |
| Inorganic | 39.13% | 0.00% | 56.42% | 0.00% | 0.00% |
| Filler % | | | | | |
| Silicic Acid | 8.06% | 0.00% | 8.74% | 0.00% | 0.00% |
| Sodium Salt | | | | | |
| Particle % | | | | | |

All Powders C, D, E, F & G were poured into a washing bowl containing 3 litres of Water with a hardness of 22 grains per gallon at 25 degrees C., to make wash liquors of concentration of 210 ppm of Linear Alkyl Benzene Sulphonate & 210 ppm of Alkyl Sulphate, for all 5 cases. 3 seconds after powder was poured in the bowl, a controlled & automated foam generation process by hand was initiated as follows, using a robot hand:
Stage 1: 10 seconds of moderate dispersion consisting of 12 loops
Stages 2, 3 & 4:5 loops, followed by 10 diagonal slashes along the length of the bowl (from top left to bottom right), then 10 diagonal slashes along the length of the bowl (from top right to bottom left). The entire cycle lasts 14 seconds.

The volume of suds generated was measured using a depth camera, and results are displayed in Table 6.

As it can be observed in Table 6, the largest and quickest foam volume was achieved with Powder G, where the Alkyl Sulphate, Alkyl Benzene Sulphonate and Sodium Carbonate were co-located in the same Particle.

TABLE 6
Foam volume generated by controlled Hand
agitation process (mililitres of foam)

| | POWDER | POWDER | POWDER | POWDER | POWDER |
|---|---|---|---|---|---|
| | C | D | E | F | G |
| After Stage 1 | 39.2 | 123.5 | 194.5 | 158.4 | 646.6 |
| After Stage 2 | 1123.3 | 1276.7 | 1252.2 | 1389.1 | 1417.1 |
| After Stage 3 | 1228.7 | 1350.6 | 1429.3 | 1593.0 | 1745.3 |
| After Stage 4 | 1275.4 | 1558.6 | 1551.6 | 1801.4 | 1934.8 |
| After Stage 5 | 1363.8 | 1779.7 | 1588.2 | 1960.4 | 2053.4 |

As can be seen from Table 6, Powder G according to the present invention exhibit higher foam height than any of the comparative ones, irrespective of manufacturing route or particle size.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

What is claimed is:

1. A laundry detergent composition, wherein said composition comprises at least a first granule, wherein said first granule comprises an anionic surfactant;
wherein said first granule comprises between about 2% and about 40% by weight of the first granule of the anionic surfactant, and wherein the anionic surfactant comprises linear alkylbenzene sulphonate and linear alkyl sulphate, and wherein the weight ratio of linear alkylbenzene sulphonate to alkyl sulphate is between 0.5:1 to 2:1.

2. The detergent composition according to claim 1, wherein said granular laundry detergent composition comprises between about 2% and about 40% by weight of the granular laundry detergent composition of the anionic surfactant.

3. The detergent composition according to claim 1 wherein cation from the linear alkylbenzene sulphonate is selected from alkali and alkaline earth metals.

4. The detergent composition according to claim 1 the linear alkylbenzene sulfonate has a chain length of C8, C10, C12, C14, C16, or mixtures thereof.

5. The detergent composition according to claim 1 wherein the linear alkyl sulphate is selected from alkali and alkaline earth metals or mixtures thereof.

6. The detergent composition according to claim 1 wherein the linear alkyl sulphate has a chain length of C8, C10, C12, C14, C16, C18 or mixtures thereof.

7. The detergent composition according to claim 6, wherein the linear alkyl sulphate is unethoxylated or ethoxylated.

8. The detergent composition according to claim 7, wherein the linear alkyl sulphate is unethoxylated.

9. The detergent composition according to claim 7, wherein, the linear alkyl sulphate is ethoxylated, and has an average degree of ethoxylation of between 1 and 25.

10. The detergent composition according to claim 1, wherein said first granule further comprise an inorganic salt.

11. The detergent composition according to claim 10, wherein the inorganic salt is selected from alkali metal salts, alkaline earth metal salts or a mixture thereof.

12. The detergent composition according to claim 11, wherein the inorganic salt is selected from alkali metal carbonate, alkali metal sulphate, alkali metal silicate, alkali metal chloride, or a mixture thereof.

13. The detergent composition according to claim 1, wherein the first granule comprises dyes, ethoxylated material or a mixture thereof.

14. The detergent composition according to claim 1, wherein the first granule is in the form of a spray-dried granule, an agglomerate, drum dried flake, an extrudate or a mixture thereof.

15. The detergent composition according to claim 1, comprising at least a second granule, wherein the second granule comprises a polymer, hueing dye, enzyme, optical brightener, perfume, alkali source, inorganic filler, supplementing surfactant particle, or a mixture thereof.

16. The detergent composition according to claim 1, wherein said composition comprises between about 0.1 and about 99% by weight of the composition of the first granule.

17. The detergent composition according to claim 1, wherein the detergent composition is in the form of a free flowing granular detergent, a compressed tablet, a unit dose article wherein the detergent composition is contained within and/or on the unit dose article, or a mixture thereof.

18. A process for making a granular laundry detergent composition according to claim 1 comprising the steps of;
a. creating a slurry comprising the anionic surfactant;
b. converting said slurry in a plurality of the first granule;
c. optionally mixing the first granule with the second granule.

19. The process according to claim 18, wherein the alkyl sulphate is first mixed with the linear alkylbenzene sulphonate to create an intermediate mixture.

20. A process of washing a fabric comprising the steps of;
d. mixing water and a granular laundry detergent composition according to claim 1 to create a wash liquor;
c. adding a fabric to be cleaned to said wash liquor;
f. agitating the wash liquor and fabric by hand.
